(19) United States
(12) Patent Application Publication
(10) Pub. No.: US 2018/0095835 A1
(43) Pub. Date: Apr. 5, 2018

(54) RESILIENT ANALYTICS UTILIZING DARK DATA

(71) Applicant: INTERNATIONAL BUSINESS MACHINES CORPORATION, Armonk, NY (US)

(72) Inventors: Orry Dubois, Wake Forest, NC (US); Greg Holzman, Bayonne, NJ (US)

(21) Appl. No.: 15/285,915

(22) Filed: Oct. 5, 2016

(51) Int. Cl. G06F 11/14; G06F 17/30

(52) U.S. Cl. CPC G06F 11/1451; G06F 17/30215

(57) ABSTRACT

Systems and methods for resilient analytics utilizing dark data are disclosed. In aspects, a computer-implemented method comprises: receiving, by an active production data storage server, encoded backup data from a client server; storing, by the active production data storage server, the encoded backup data in a backup data storage module; automatically replicating and decoding, by a resiliency data server, the encoded backup data in the backup data storage module, wherein the decoding transforms the encoded backup data from an encoded format to unencoded data; saving, by the resiliency data server, the unencoded data in an unencoded data storage module; receiving, by an analytics module, the unencoded data; and processing, by the analytics module, the unencoded data utilizing one or more analytics tools to produce an analytics output based on business objective data of a client; and providing, by the analytics module, the analytics output to the client.

### STATEMENT REGARDING PRIOR DISCLOSURES BY THE INVENTOR OR A JOINT INVENTOR

The following disclosures are submitted under 35 U.S.C. § 102(b)(1)(A): IBM web site, “Data Availability as a Service”, http://www-935.ibm.com/services/us/en/it-services/business-continuity/data-availability-as-a-service/index.html, made publicly available March 2016, 2 pages; and IBM fact sheet “IBM Data Availability as a Service”, https://public.dhe.ibm.com/common/ssi/ecm/bu/en/buj03143usen/BUJ03143USEN.PDF, made publicly available March 2016, 2 pages.

### BACKGROUND

The present invention relates generally to business analytics and, more particularly, to a system and method for utilizing dark data for resilient analytics. Today, every discussion about changes in business and technology must begin with data. As data has increased exponentially in volume and type over the past decade, it has become the basis of competitive advantage and transformation. Presently, analytics services are available to businesses that provide a business with the ability to analyze their business data to obtain useful information. Such services utilize so-called business intelligence (BI). As used herein, the term BI includes computer-based techniques used in identifying, obtaining, extracting, and/or analyzing business data. However, such services may require a large investment in technical resources and service costs. Specifically, large data storage devices and processors are necessary to configure business data and run analytics software. Such systems are very business specific, and require technical expertise to set up data access/permissions to harvest necessary business data, which can be stored over a wide array of devices and which can be in various formats, both encrypted and non-encrypted. Further, harvesting of data from a user's computer systems can affect the system's performance (e.g., slow the system down). Changes in a company's computer systems can require updates to the analytics software and to the access/permissions associated therewith. Accordingly, small business with fewer resources to allocate to computer infrastructure and services are unlikely to have meaningful access to data analytics. Additionally, any manipulation of data, including data analytics processes, has the potential to corrupt data. Accordingly, any original sources of data subjected to analytics processing are potentially subject to corruption.

With the constant emergence of new regulations, security threats and service outages, it is getting harder for businesses to maintain continuous availability of their mission-critical information technology (IT) systems. Without a robust server recovery and data backup solution, minor disruptions can significantly impact overall business performance. Presently, off-site server recovery and data backup solutions are available to provide customers with return of operation (RTO) and recovery point objectives (RPO), without requiring the necessary onsite backup resources. However, such solutions utilize data encoding to efficiently transmit data to an off-site recovery and data backup system. As used herein, the term “encoding” should be understood to means the process of putting a sequence of characters (letters, number, punctuation, and certain symbols) into a specialized format to produce encoded data (e.g., compressed data) for efficient transmission and storage. Such encoded data is “dark” data, in that it is in a format that is unusable for objectives other than data recovery.

### SUMMARY

In an aspect of the invention, a computer-implemented method includes: receiving, by an active production data storage server, encoded backup data from a client server; storing, by the active production data storage server, the encoded backup data in a backup data storage module; automatically replicating and decoding, by a resiliency data server, the encoded backup data in the backup data storage module, wherein the decoding transforms the encoded backup data from an encoded format to unencoded data having an unencoded format; saving, by the resiliency data server, the unencoded data in an unencoded data storage module; receiving, by an analytics module, the unencoded data; and processing, by the analytics module, the unencoded data utilizing one or more analytics tools to produce an analytics output based on business objective data of a client; and providing, by the analytics module, the analytics output to the client.

In another aspect of the invention, there is a computer program product for utilizing dark data for resilient analytics. The computer program product comprises a computer readable storage medium having program instructions embodied therewith. The program instructions are executable by a computing device to cause the computing device to: receive encoded backup data from a first client server; store the encoded backup data in one or more backup data storage modules; receive encoded backup data from a second client server; store the encoded backup data in the one or more data storage modules; automatically replicate and decode the encoded backup data in the one or more backup data storage modules, wherein the decoding transforms the encoded backup data from an encoded format to unencoded data having an unencoded format; save the unencoded data in one or more unencoded data storage modules; and transfer the unencoded data to a merger module connected to an analytics module, wherein the merger module is configured to merge the unencoded data with supplementary data to produce merged data, and transfer the merged data to the analytics module for processing.

In another aspect of the invention, there is a system for utilizing dark data for resilient analytics. The system comprises a CPU, a computer readable memory and a computer readable storage medium associated with a computing device; program instructions to receive encoded backup data from a client server; program instructions to store the encoded backup data in a backup data storage module; program instructions to automatically replicate and decode the encoded backup data in the backup data storage module, wherein the decoding transforms the encoded backup data from an encoded format to unencoded data having an unencoded format; program instructions to save the unencoded data in an unencoded data storage module; program instructions to process the unencoded data utilizing one or more analytics tools to produce an analytics output based on business objective data of a client; and program instructions to provide the analytics output to the client, wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 depicts a cloud computing environment according to an embodiment of the present invention.

FIG. 3 depicts abstraction model layers according to an embodiment of the present invention.

FIG. 4 shows an exemplary environment in accordance with aspects of the invention.

FIG. 5 shows a flowchart of steps of a method in accordance with aspects of the invention.

FIG. 6 shows a resilient analytics scenario in accordance with aspects of the invention.

### DETAILED DESCRIPTION

The present invention relates generally to business analytics and, more particularly, to a system and method for utilizing dark data for resilient analytics. In aspects of the invention a disaster recovery system in a cloud computing environment combines hardware and software to replicate data from a primary (client) site to a recover and resiliency data center. The system protects mission-critical data and facilitates virtually immediate availability of data for disaster recover, while freeing previously “dark” data. Once client data is at a recovery and resiliency data center, it is utilized by an analytics module for a variety of purposes, including development testing (dev/test), compliance reporting and business analytics. In aspects the system of the present invention utilizes shared and dedicated assets to provide a cost effective solution to data recovery and analytics, while assuring absolute security for the client's data through segregation and access controls.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

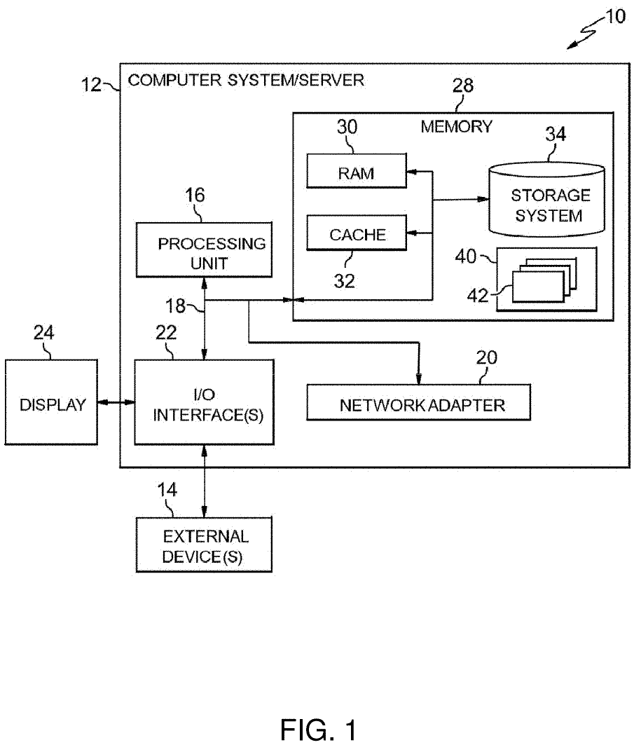

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

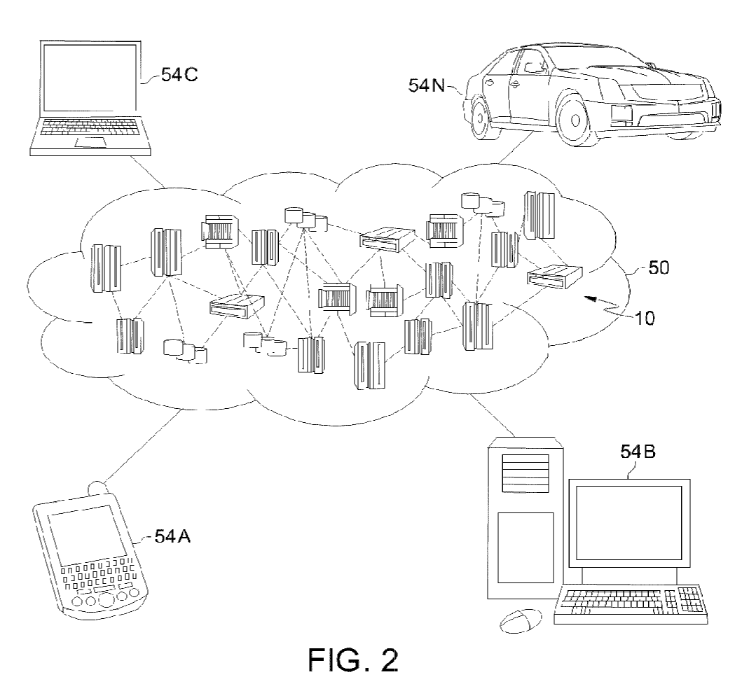

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

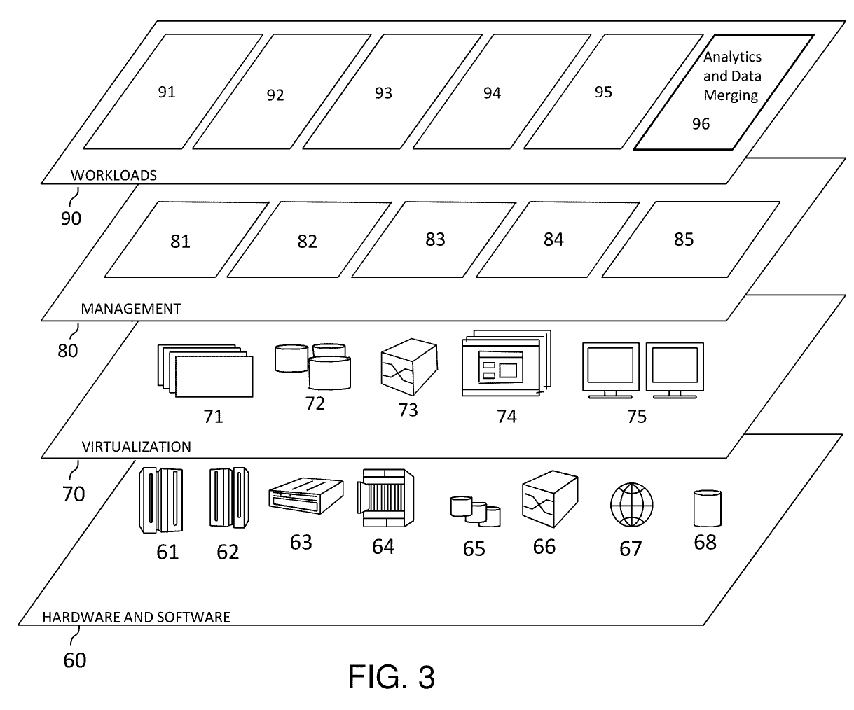

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and analytics and data merging 96.

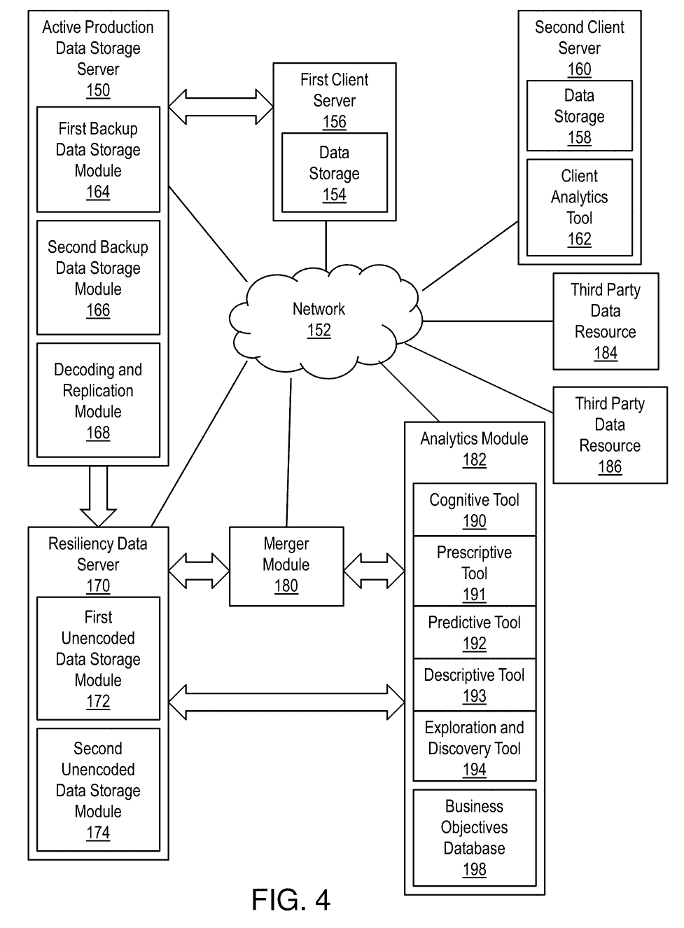

Referring back to FIG. 1, the program/utility 40 may include one or more program modules 42 that generally carry out the functions and/or methodologies of embodiments of the invention as described herein, such as the functionally of analytics and data merging 96 of FIG. 3. Specifically, the program modules 42 may perform data analytics techniques and merge data for use in the data analytics techniques. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be implemented in the environment shown in FIG. 4.

FIG. 4 shows an exemplary environment in accordance with aspects of the invention. The environment includes an active production data storage server 150 connected to a network 152. In aspects, the active production data storage server 150 includes a plurality of encoded data storage modules for storing client data. The active production data storage server 150 may comprise a computer system 12 of FIG. 1, and may be connected to the network 152 via the network adapter 20 of FIG. 1. The active production data storage server 150 may be part of a client's on-site data backup system, or may be configured as a special purpose computing device that is part of a cloud-based data storage and recovery system for providing disaster recovery and analytics services to a plurality of clients or businesses. In aspects, the active production data storage server 150 is configured to retrieve or receive encoded backup data from a data storage unit 154 of a first client server 156 and a data storage unit 158 of a second client server 160 over the network 152, and store the encoded backup data in respective first and second backup data storage modules 164 and 166. Conventional techniques for encoding and storing backup data can be utilized.

In embodiments, the active production data storage server 150 further includes a decoding and replication module 168 for decoding and replicating the encoded data stored in the first and second backup data storage modules 164 and 166. It should be understood that the active production data storage server 150 may include any number of backup data storage modules to accommodate data from any number of client servers (e.g., first and second client servers 156 and 160).

The network 155 may be any suitable communication network or combination of networks, such as a local area network (LAN), a general wide area network (WAN), and/or a public network (e.g., the Internet). Each of the first and second client servers 156 and 160 may comprise components of the computer system 12 of FIG. 1, and may be configured as special purpose computing devices that are part of a client's internal disaster recovery systems. In embodiments, one or more client servers may include a client analytics tool, such as client analytics tool 162 of the second client server 160. The analytics tool 162 may be any conventional combination of hardware and software for providing data analytics output or BI applications to a client.

Still referring to FIG. 4, a resiliency data server 170 is in communication with the active production data storage server 150, either directly or through the network 152. The resiliency data server 170 may comprise components of the computer system 12 of FIG. 1, and may be connected to the network 152. The resiliency data server 170 may be configured as a special purpose computing device that is part of the cloud-based data storage and recovery system referenced above. In aspects, the resiliency data server 170 is configured to retrieve or receive replicated unencoded (e.g., decompressed) data from the active production data storage server 150, for storing in respective first and second unencoded data storage modules 172 and 174. It should be understood that the resiliency data server 170 may include any number of unencoded data storage modules, and the first and second unencoded data storage modules 172 and 174 discussed herein are provided for illustrative purposes only.

In embodiments, a merger module 180 is provided in communication with the resiliency data server 170 and an analytics module 182, either directly or through the network 152. The merger module 180 may also be in communication, either directly or through the network 152, with one or more supplementary data sources 184 and 186. The merger module 180 is configured to perform one or more of the functions described herein. The merger module 180 may include one or more program modules (e.g., program module 42 of FIG. 1) executed by a computer device (not separately labeled). In embodiments, the merger module 180 is configured to retrieve or receive unencoded client data from the resiliency data server 170, and merge the unencoded client data with other unencoded client data (e.g., data from another client as part of a cooperative analytics program), or with data retrieved or received from supplementary data sources, such as client analytics data from the client analytics tool 162, and third party data from the third party data sources 184 and 186, to produce merged data.

Referring once more to FIG. 4, in embodiments the analytics module 182 is provided in communication with one or more client servers (e.g., 156, 160) through the network 152. Additionally, in aspects, the analytics module 182 may be in direct communication with the merger module 180 and the active production data storage server 150, and/or may be indirectly in communication with the merger module 180 and the active production data storage server 150 through the network 152. The analytics module 182 is configured to perform one or more of the functions described herein. The analytics module 182 may include one or more program modules (e.g., program module 42 of FIG. 1) executed by a computer device (not separately labeled). In aspects, the analytics module 182 is configured to retrieve or receive unencoded backup data from the resiliency data server 170. In addition or alternatively, the analytics module 182 is configured to retrieve or receive merged data from the merger module 180. The analytics module 182 may be any conventional analytics system, which is capable of analyzing data to provide answers to business questions in the form of an analytics output. In embodiments, the analytics module 182 includes a cognitive tool 190 enabling the analytics module 182 to learn dynamically based on received data; a prescriptive tool 191 enabling the analytics module 182 to determine best outcomes based on received data; a predictive tool 192 enabling the analytics module 182 to predict possible outcomes based on received data; a descriptive tool 193 enabling the analytics module 182 to describe what has occurred based on the received data; and an exploration and discovery tool 194 enabling the analytics module 182 to ascertain what it is a client has based on the received data.

In embodiments, a service provider provides the active production data storage server 150, the resiliency data server 170, the merger module 180 and the analytics module 182 as a cloud-based system enabling the use of the client's dark data (encoded backup data) for resilient analytics. Advantages associated with such a system include the ability to safeguard critical backup data for disaster recovery, while utilizing a replica of the data for on-demand analytics, without affecting the client's backup data or original data at a client server cite. Moreover, by transforming encoded backup data to a usable unencoded replica of the backup data, and using the unencoded replica data rather than original data at a client server, the function of the client server is improved by removing a processing burden (e.g., no select harvesting of data for analytics processing), while providing the client with the ability to obtain analytics data at any time.

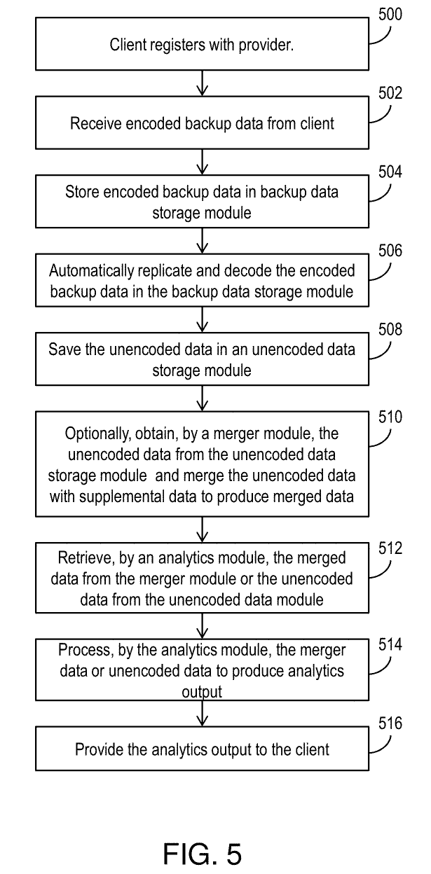

FIG. 5 shows a flowchart of a method in accordance with aspects of the invention. Steps of the method of FIG. 5 may be performed in the environment illustrated in FIG. 4, and are described with reference to elements shown in FIG. 4.

In embodiments, a client registers with a provider at step 500. In aspects, during the registration process, the client provides business objective data to the provider, which may be stored in the business objectives database 198. Other information may be obtained from the client during the registration process, such as rules for storing encoded backup data and restoring the encoded backup data to the client during a disaster recovery event.

At step 502, encoded backup data (encoded replicated client data) is received at an active production data storage server 150 from a client server (e.g., 156 or 160). In embodiments, the active production data storage server 150 is remote from the client server (e.g., 156 or 160), and receives the encoded backup data over an internet connection. Conventional methods of encoding and retrieving backup data may be utilized in accordance with the present invention.

At step 504, the encoded backup data is stored by the active production data storage server 150 in an appropriate backup data storage module (e.g., 164). In aspects, each storage module is dedicated to a specific client and includes conventional security measures to ensure security of the encoded backup data stored therein. In aspects, the active production data storage server 150 is remote from the client server (e.g., 156, 160), and is synchronized to a crash consistent point in time in a format usable for application recovery and business resumption protocols.

At step 506, the decoding and replication module 168 of the active production data storage server 150 replicates and decodes the encoded backup data in the client's backup data storage module (e.g., 164) to produce unencoded data. Conventional methods for decoding encoded backup data (e.g., compressed data) may be utilized in accordance with the present invention. The unencoded backup data is in a form usable by the analytics module 182. In embodiments, the replication and decoding of the encoded backup data is automatic. In aspects, data replication and decoding is continuous, regardless of how many virtual copies are created.

At step 508, the unencoded data is saved in an appropriate unencoded data storage module (e.g., 172) of the resiliency data server 170. In aspects, each unencoded data storage module (e.g, 172, 174) of resiliency data server 170 is dedicated to a specific client and includes conventional security measures to ensure security of the encoded backup data stored therein. In embodiments, unencoded data stored in the resiliency data server 170 is encrypted, either by the active production data storage server 150, or by the resiliency data server 170.

In embodiments, at step 510, the merger module 180 obtains a client's unencoded data from the resiliency data server 170 and merges the unencoded data with supplemental data to produce merged data. In embodiments, the merger module 180 obtains supplemental data from the client analytics tool 162. In embodiments, the merger module 180 obtains supplemental data from third party data sources (e.g., 184, 186). Examples of third party data sources include sources of weather data, sources of geo spatial data (e.g., GPS data) and sources of social media data.

At step 512, the analytics module 182 retrieves or receives either the merged data from the merger module 180, or the unencoded data from the resiliency data server 170 (e.g., client data from the first unencoded data storage module 172).

At step 514, the analytics module 180 processes the merged data or the unencoded data from step 512, to produce an analytics output. The analytics module 180 may utilize conventional analytics techniques to produce the analytics output. Advantageously, because the unencoded data at the resiliency data server 170 is isolated from the client's actual production systems, immediate analytical benefits can be derived from the unencoded data without burdening the client's production systems for processing cycles, infrastructure demands (power, cooling, cabinetry, etc.), security clearances, change control, project management and other IT asset considerations (storage, core switching assignments, load balancing, etc.).

At step 516, the analytics output from the analytics module 182 is provided to the client. Conventional analytics output techniques may be utilized with the present invention. By way of example, the analytics module 182 or a computer resource associated therewith may provide a dashboard or scoreboard accessible through a web portal to display analytics output to a client in an understandable format.

An example of how the method of FIG. 5 may be utilized will now be discussed with reference to FIGS. 4 and 5. In this illustrative example, a first client server 156 is in the form of an automated teller machine (ATM) server, which records ATM transaction data in the data storage 154. A replica of the transaction data in the data storage 154 is sent to the active production data storage server 150, as encoded backup data, and saved in the first backup data storage module 164 (steps 502 and 504). The decoding and replication module 168 automatically decodes and replicates the encoded backup data from the first backup data storage module 164, and stores it as unencoded data in the first unencoded data storage module 172 (steps 506 and 508). The analytics module 180 retrieves the unencoded data from the first unencoded data storage module 172 based on client rules and objectives stored in the business objectives database 198 (step 512). In this example, analytics module 182 retrieves 30 days worth of ATM transaction data on a regular scheduled basis, in order to analyze the data to predict malicious intent utilizing the predictive tool 192. The analytics module 180 then processes the 30 days worth of ATM transaction data utilizing the predictive tool 192, and generates analytics output data to the client (ATM owner) via a web portal (not shown), in accordance with steps 514 and 516 of the present invention. Advantageously, no opportunity exists for corruption of original ATM records by the analytics module 180, since the analytics module 180 relies on data replicated from encoded backup data, which is automatically sent to the active production data storage server 150 in accordance with data protection and recovery procedures.

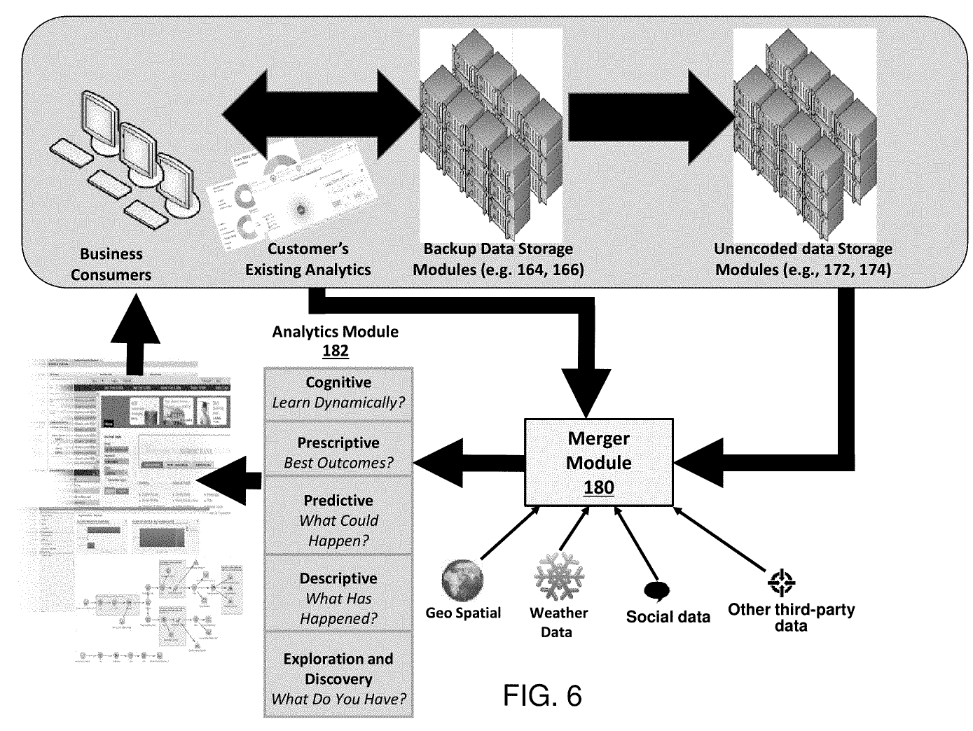

FIG. 6 depicts a resilient analytics scenario in accordance with aspects of the invention. FIGS. 4, 5 and 6 will now be referenced with respect to a discussion of the exemplary scenario. In this illustrative example, the first client server 156 is in the form of a computer of a first farmer, which stores records associated with, for example, crops. In this scenario, the second client server 160 is a computer of a second farmer, who is participating in the same cooperative pooling of resources as the first farmer. A replica of the crop data in the data storage 154, as well as a replica of the crop data in data storage 158, is sent to the active production data storage server 150, as encoded backup data, and saved in one or more backup data storage modules 164, 166 (steps 502 and 504). The decoding and replication module 168 automatically decodes and replicates the encoded backup data from the one or more backup data storage modules 164, 166, and stores it as unencoded data in one or more unencoded data storage modules 172, 174 (steps 506 and 508). The merger module 180 retrieves the unencoded data from the one or more unencoded data storage modules 172, 174 based on client rules and objectives stored in the business objectives database 198 (step 510). The merger module 180 also retrieves supplementary data in the form of geo spatial data and weather data, and merges the unencoded data and the supplementary data to produced merged data (step 510). The analytics module 182 obtains the merged data and processing it utilizing one or more of cognitive tools (e.g., 190-194) to produce analytics output, in accordance with steps 512 and 514 of the present invention. The analytics output can then be provided as a shared resource to the first and second farmers in accordance with step 516 of the present invention. As illustrated by this scenario, the present invention enables cooperative resource pooling of clients to provide more robust analytics information, without requiring the client to purchase and maintain customized computer analytics systems.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that could benefit from business analytics. In return, the service provider can receive payment from the customer(s) under a subscription and/or fee agreement and/or the service provider can receive payment from the sale of advertising content to one or more third parties.

In still another embodiment, the invention provides a computer-implemented method for utilizing dark data for resilient analytics. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by an active production data storage server, encoded backup data from a client server;
storing, by the active production data storage server, the encoded backup data in a backup data storage module;
automatically replicating and decoding, by a resiliency data server, the encoded backup data in the backup data storage module, wherein the decoding transforms the encoded backup data from an encoded format to unencoded data having an unencoded format;
saving, by the resiliency data server, the unencoded data in an unencoded data storage module;
receiving, by an analytics module, the unencoded data;
processing, by the analytics module, the unencoded data utilizing one or more analytics tools to produce an analytics output based on business objective data of a client; and
providing, by the analytics module, the analytics output to the client.

2. The computer-implemented method of claim 1, further comprising:
receiving, by a merger module, the unencoded data from the unencoded data storage module; and
merging, by the merger module, the unencoded data with supplementary data to produce merged data;
wherein the receiving, by the analytics module, the unencoded data comprises receiving the merged data; and
wherein the processing, by the analytics module, the unencoded data utilizing the one or more analytics tools comprises process the merged data.

3. The computer-implemented method of claim 2, further comprising receiving, by the merger module, the supplementary data in the form of client analytics data from a client analytics tool.

4. The computer-implemented method of claim 2, further comprising receiving, by the merger module, the supplementary data in the form of third party data from a third party data source.

5. The computer-implemented method of claim 1, wherein the supplementary data includes weather data.

6. The computer-implemented method of claim 1, wherein the supplementary data includes social media data.

7. The computer-implemented method of claim 1, wherein the analytics output includes data regarding malicious behavior.

8. The computer-implemented method of claim 1, further comprising encrypting the unencoded data stored in the unencoded data storage module.

9. The computer-implemented method of claim 1, wherein the method is performed in a cloud environment.

10. A computer program product for utilizing dark data for resilient analytics, the computer program product comprising a computer readable storage medium having program instructions embodied therewith, the program instructions executable by a computing device to cause the computing device to:
receive encoded backup data from a first client server;
store the encoded backup data in one or more backup data storage modules;
receive encoded backup data from a second client server;
store the encoded backup data in the one or more data storage modules;
automatically replicate and decode the encoded backup data in the one or more backup data storage modules, wherein the decoding transforms the encoded backup data from an encoded format to unencoded data having an unencoded format;
save the unencoded data in one or more unencoded data storage modules; and
transfer the unencoded data to a merger module connected to an analytics module, wherein the merger module is configured to merge the unencoded data with supplementary data to produce merged data, and transfer the merged data to the analytics module for processing.

11. The computer program product of claim 10, wherein the program instructions further cause the computing device to encrypt the unencoded data stored in the unencoded data storage module.

12. A system for utilizing dark data for resilient analytics, comprising:
a CPU, a computer readable memory and a computer readable storage medium associated with a computing device;
program instructions to receive encoded backup data from a client server;
program instructions to store the encoded backup data in a backup data storage module;
program instructions to automatically replicate and decode the encoded backup data in the backup data storage module, wherein the decoding transforms the encoded backup data from an encoded format to unencoded data having an unencoded format;
program instructions to save the unencoded data in an unencoded data storage module;
program instructions to process the unencoded data utilizing one or more analytics tools to produce an analytics output based on business objective data of a client; and
program instructions to provide the analytics output to the client,
wherein the program instructions are stored on the computer readable storage medium for execution by the CPU via the computer readable memory.

13. The system of claim 12, further comprising:
program instructions to receive supplementary data; and
program instructions to merge the unencoded data with the supplementary data to produce merged data, wherein processing the unencoded data utilizing the one or more analytics tools comprises process the merged data.

14. The system of claim 13, wherein the supplementary data is in the form of client analytics data from a client analytics tool.

15. The system of claim 13, wherein the supplementary data is in the form of third party data from an online third party data source.

16. The system of claim 15, wherein the supplementary data includes weather data.

17. The system of claim 15, wherein the supplementary data includes social media data.

18. The system of claim 12, wherein the analytics output includes data regarding malicious behavior.

19. The system of claim 12, further comprising program instructions to encrypt the unencoded data stored in the unencoded data storage module.

20. The system of claim 12, wherein the system is operated in a cloud environment.
